(19) United States
(12) Patent Application Publication
(10) Pub. No.: US 2010/0209564 A1
(43) Pub. Date: Aug. 19, 2010

(54) EDIBLE FAT AND OIL COMPOSITIONS

(75) Inventors: Takeshi Kamegai, Kanagawa (JP); Reiko Ejiri, Kanagawa (JP); Tetsuro Iwasawa, Kanagawa (JP); Michio Kasai, Kanagawa (JP)

Correspondence Address: BUCHANAN, INGERSOLL & ROONEY PC, POST OFFICE BOX 1404, ALEXANDRIA, VA, 22313-1404, US

(73) Assignee: The Nisshin OilliO Group, Ltd., Chuo-ku, Tokyo (JP)

(21) Appl. No.: 12/681,494

(22) PCT Filed: Oct. 3, 2008
(86) PCT No.: PCT/JP2008/068059

§ 371 Date: Apr. 2, 2010

(30) Foreign Application Priority Data
Oct. 3, 2007 (JP) 2007-260058
Feb. 15, 2008 (JP) 2008-034869

(51) Int. Cl. A23D 9/00; A23L 1/01

(52) U.S. Cl. 426/106; 426/607; 426/438

(57) ABSTRACT

The present invention discloses an edible fat and oil composition having a good flavor. The present invention also discloses an edible fat and oil composition comprising palm olein having an iodine value of 64 or more, corn oil and rapeseed oil.

### TECHNICAL FIELD OF THE INVENTION

The present invention relates to edible fat and oil compositions, in particular, edible fat and oil compositions having a good flavor.

### BACKGROUND OF THE INVENTION

A fat and oil composition is widely used in food field, and not only is it used as a heating medium for use in heat-processing of foods but it is also often used as a material of a seasoning agent.

Therefore, in terms of using oil as a raw material of processed products such as a seasoning agent as well as using it as a heating medium, it has been desired to suppress the flavor deterioration of oil.

Various considerations have been made in order to solve this problem. In the following patent literature, the odor in bright light that is generated by photooxidation of an edible fat and oil in a container is suppressed by adding an ultraviolet absorbing agent to the container of a edible fat and oil and, as a result, the flavor deterioration of oil is suppressed.

Patent Literature 1: JP-A 7-322819

### DISCLOSURE OF THE INVENTION

However, it was difficult to add an ultraviolet absorbing agent to all kinds of containers of an edible fat and oil made of different materials and form them as a container.

In view that an edible fat and oil is often used as a material of processed products such as a seasoning agent, it has been desired to develop an edible fat and oil having better taste, not only after the oil is exposed to a degradation environment but also in the fat and oil before the oil is exposed to a degradation environment.

The inventors thoroughly searched to solve the problem and found that oil having nonconventional characteristics, in particular, oil having both a delicious flavor and lightness can be obtained by combining a specific palm olein, corn oil and rapeseed oil. The present invention has been completed based on this finding.

Accordingly, the present invention provides an edible fat and oil composition comprising palm olein having an iodine value of 64 or more, corn oil and rapeseed oil.

The present invention also provides an edible fat and oil composition comprising palm olein having an iodine value of 64 or more, corn oil and rapeseed oil, wherein the total amount of the palm olein, the corn oil and the rapeseed oil in the whole edible fat and oil composition is 50-100 mass %; the mass ratio of the palm olein to the total amount of the corn oil and the rapeseed oil is 20:80-80:20; and the mass ratio of the corn oil and the rapeseed oil is 20:80-80:20.

The present invention further provides an edible fat and oil composition comprising palm olein, corn oil and rapeseed oil, wherein the composition is filled in a container having a volume of 2 L or less, at least a part of which is formed of a light transmissive material.

The present invention further provides a method for producing a cooked food which comprises cooking food materials using either one of the above edible fat and oil compositions.

The present invention further provides a food which is produced by using either one of the above edible fat and oil compositions.

### BEST MODE FOR CARRYING OUT THE INVENTION

The edible fat and oil composition of the present invention can be obtained by combining palm olein, corn oil and rapeseed oil, and optionally other components. Each component and their formulated amounts. etc. are further illustrated below.

### Palm Olein

In the present invention, “palm olein” indicates an edible liquid oil, which is obtained by fractionating and purifying oil collected from a fruit of an oil palm.

Among the above palm olein, palm olein of the edible fat and oil composition of the present invention is preferably selected from those having an iodine value of 64 or more, more preferably those having an iodine value of 64-80, further more preferably those having an iodine value of 65-72, and most preferably those having an iodine value of 66-72. When the iodine value thereof is 64 or more, an edible fat and oil composition having both a delicious flavor and lightness can be obtained.

The iodine value can be easily measured in accordance with Standard Methods for the Analysis of Fats, Oils and Related Materials 2.3.4.1-1996 (Japan Oil Chemists' Society), for example.

More preferably, in the present invention, palm olein can be used which comprises, as the constituent fatty acids, fatty acids having 18 carbon atoms and at least one unsaturated bond(s) at an amount of 58-68 mass %, more preferably 58-66 mass %, and most preferably 58-65 mass % in all constituent fatty acids of the palm olein. When the constituent fatty acids of palm olein are within the above range, an edible fat and oil composition having both a delicious flavor and lightness can be obtained.

The above palm olein can be obtained by fractionating palm oil. More specifically, the clusters of oil palm are treated with steam and compressed to produce oil thereof. The produced oil is centrifuged to remove fibers and impurities and dried. Then, the oil is purified by degumming, deacidification, bleaching and deodorization. Examples of the refining method include chemical refining and physical refining, and either of them is usable.

The fractionation method of palm oil for obtaining palm olein is not particularly limited, and natural fractionation by cooling is usually used. It is also possible to use the fractionation method with a surfactant or a solvent. Palm olein is a medium-melting-point part or a low-melting-point part each of which is obtained by fractioning palm oil (a high-melting-point part is generally referred to as palm stearin). This fractionation can be conducted twice or three times, and it is possible to comprise a low-melting-point part obtained by fractionating several times in the edible fat and oil composition of the present invention, particularly those having an iodine value within the above range measured in accordance with the above method.

### Rapeseed Oil

As rapeseed oil used in the present invention, it is possible to use edible rapeseed oil generally distributed. Examples of rapeseed oil include canola oil in which the content of an oleic acid in all constituent fatty acids is less than 70 mass %, and high-oleic low-linolenic canola oil in which the content of an oleic acid in all constituent fatty acids is 70 mass % or more. Taking into account the cost, it is preferable to use canola oil in which the content of an oleic acid in all constituent fatty acids is less than 70 mass %.

### Corn Oil

As corn oil used in the present invention, it is possible to use edible corn oil generally distributed.

Further, in the present invention, corn oil can be used which comprises, as the constituent fatty acids, fatty acids having 18 carbon atoms and at least one unsaturated bond(s) at an amount of 60-100 mass %, more preferably 70-95 mass %, and most preferably 75-90 mass % in all constituent fatty acids of the corn oil. When the constituent fatty acids of corn oil are within the above range, an edible fat and oil composition having both a delicious flavor and lightness can be obtained. Other components In the edible fat and oil composition of the present invention, it is possible to comprise other oils and additives each of which are usually used in edible oils, without departing from the scope of the invention.

Examples of the above oils include generally-used edible oils such as safflower oil, grape seed oil, soybean oil, sunflower oil, cotton seed oil, sesame oil, Taihaku sesame oil, rice oil, peanut oil, olive oil, flaxseed oil, transesterified fats and oils, fats and oils having medium-chain fatty acids as constituent fatty acids, and fats and oils having medium-chain fatty acids and long-chain fatty acids as constituent fatty acids. Particularly, when comprising plenty of other oils, it is preferable to use safflower oil, sunflower oil, Taihaku sesame oil, fats and oils having medium-chain fatty acids as constituent fatty acids, or fats and oils having medium-chain fatty acids and long-chain fatty acids as constituent fatty acids.

Examples of the additives include antioxidants, nutrient enrichment agents, emulsifying agents, coloring components and antifoamers.

Examples of the antioxidants include tocopherols, tocotrienols, carotene, flavone derivatives, gallic acid derivatives, catechin and the esters thereof, sesamol and terpenes.

Examples of the nutrient enrichment agents include tocopherols, tocotrienols, phytosterols, esters of phytosetrols, γ-orizanol, astaxanthin, coenzyme Q10, carotene, capsaicin and capsiate.

In the present specification, examples of tocopherols include α-tocopherol, β-tocopherol, γ-tocopherol and δ-tocopherol. Further, examples of tocotrienols include α-tocotrienol, β-tocotrienol, γ-tocotrienol and δ-tocotrienol.

Examples of the emulsifying agents include polyglycerol esters of fatty acids, polyglycerol esters of polyricinoleic acid, sucrose esters of fatty acids, sorbitan esters of fatty acids, polysorbate, glycerol esters of mono-fatty acids, organic esters of glycerol esters of mono-fatty acids, propylene glycol esters of fatty acids and lecithin.

Examples of antifoamers include fine silica powder and silicone.

The edible fat and oil composition of the present invention more preferably comprises carotene among the other components. Examples of carotene include α-carotene and β-carotene. By comprising carotene therein, effects such as maintaining good eyesight during the night and maintaining the health of the skin and mucosa are expected.

The edible fat and oil composition more preferably comprises coenzyme Q10. By comprising coenzyme Q10 therein, higher effects of antioxidant action and antiaging action, etc. are expected to be imparted to the composition.

Further, the edible fat and oil composition more preferably comprises tocotrienols and/or tocopherols. The odor or taste deterioration of the edible fat and oil composition can be further suppressed by comprising tocotrienols and/or tocopherols, due to the antioxidant action thereof on fats and oils. In addition, the edible fat and oil composition can be expected to have the antioxidant action in vivo, the cholesterol-lowering effect and the arteriosclerosis ameliorating effect.

### Formulation of the Edible Fat And Oil Composition

The edible fat and oil composition of the present invention comprises the above palm olein, the corn oil and the rapeseed oil, and optionally other components. Though the formulation amount of each component is not particularly limited, the following formulation amount is more preferable in order to accomplish the object of the present invention.

In the edible fat and oil composition of the present invention, the total amount of the palm olein, the corn oil and the rapeseed oil is preferably 50-100 mass %, more preferably 70-100 mass %, and most preferably 90-100 mass %. When the formulation amount of the above three components in the whole edible fat and oil composition is 50 mass % or more, it is possible to enhance effects of the present invention, namely, to obtain an edible fat and oil composition having both a delicious flavor and lightness.

Further, in the edible fat and oil composition of the present invention, the mass ratio of the palm olein to the total amount of the corn oil and the rapeseed oil is preferably palm olein: (corn oil+rapeseed oil)=20:80-80:20, more preferably 30:70-70:30, further more preferably 30:70-60:40, and most preferably 30:70-45:55. When the mass ratio of the palm olein to the total amount of the corn oil and the rapeseed oil is within the above range, it is possible to enhance effects of the present invention, namely, to obtain an edible fat and oil composition having both a delicious flavor and lightness.

Further, in the edible fat and oil composition of the present invention, the mass ratio of the corn oil and the rapeseed oil is preferably corn oil:rapeseed oil=20:80-80:20, more preferably 30:70.70:30, and further more preferably 30:70-55:45. When the mass ratio of the corn oil and the rapeseed oil is within the above range, it is possible to enhance effects of the present invention, namely, to obtain an edible fat and oil composition having both a delicious flavor and lightness.

When the edible fat and oil composition comprises carotene, the amount of carotene in the whole edible fat and oil composition is 1-600 ppm, preferably 1-400 ppm, and more preferably 5-300 ppm. The above effects of carotene can be more effectively obtained by comprising carotene within the above range.

When the edible fat and oil composition comprises coenzyme Q10, the amount of coenzyme Q10 in the whole edible fat and oil composition is preferably 0.1-200 ppm. The above effects of coenzyme Q10 can be more effectively obtained by comprising coenzyme Q10 within the above range.

When the edible fat and oil composition comprises tocotrienols, the amount of tocotrienols in the whole edible fat and oil composition is preferably 50-900 ppm and more preferably 100-500 ppm. The above effects of tocotrienols can be more effectively obtained by comprising tocotrienols within the above range.

Further, when the edible fat and oil composition comprises tocopherols and tocotrienols, the total amount of tocopherols and tocotrienols in the whole edible fat and oil composition is preferably 200-1300 ppm. The above effects of tocopherols and tocotrienols can be more effectively obtained by comprising tocopherols and tocotrienols within the above range.

In addition, by using a mixture of palm olein, corn oil and rapeseed oil in the edible fat and oil composition of the present invention, it is possible to prevent decrease in the amounts of tocotrienols and tocopherols during the preservation. Specifically, 92-100 mass % of the total amount of tocotrienols and tocopherols originally comprised is preferably maintained after the preservation. As the preservation conditions, for example, the edible fat and oil composition is filled in a closed container at least a part of which is formed of a light transmissive material, and preserved for 12 weeks under 1000 Lux×20° C. (or preserved for 12 weeks at 40° C. in the dark).

By maintaining the contents of tocotrienols and tocopherols, it is possible to preserve a good flavor of the edible fat and oil composition and to suppress the odor deterioration thereof induced by light exposure.

Meanwhile, as for each amount of the above carotene, coenzyme Q10, tocotrienols and tocopherols, when these components are originally comprised in palm olein or rapeseed oil each of which constitutes the edible fat and oil composition of the present invention, the amounts of the components originally comprised are also added in the calculation of the above numerical values. Therefore, the above numerical values are sometimes accomplished without newly adding the components. Besides, it is also possible to accomplish the above numerical values by adding the above carotene, coenzyme Q10, tocotrienols and tocopherols as the additives.

### Method For Producing the Edible Fat And Oil Composition

The method for producing the edible fat and oil composition of the present invention is not particularly limited, and the composition is produced by stirring and mixing the palm olein, the rapeseed oil and the corn oil, and optionally the other components. The order of formulation of such components is not particularly limited. It is possible to heat the components in mixing if necessary.

### Product Forms of the Edible Fat And Oil Composition of the Present Invention

The edible fat and oil composition of the present invention can take any product form. The “product form” indicates a form in which the edible fat and oil composition is filled when transporting, preserving and selling the composition. Examples of product forms of the edible fat and oil composition of the present invention include a plastic bottle, a metallic can and pillow packaging. Since a good flavor of the edible fat and oil composition of the present invention can be preserved even after the composition is exposed to light, it is possible to fill it in a container at least part of which is formed of a light transmissive material. The “container at least part of which is formed of a light transmissive material” indicates a container a part of which has permeability that the content therein can be visually confirmed under the fluorescent light. Examples thereof include containers a part or all of which are formed of unpigmented PET, unpigmented lamicon, unpigmented glass, or the like.

Among these containers, the volume of the container is 2 L or less, and preferably 0.5-1.5 L. The edible fat and oil composition which is suitable for home use can be provided by filling the composition in such a container.

### Method For Producing A Cooked Food Using the Edible Fat And Oil Composition of the Present Invention

It is possible to produce a cooked food using the edible fat and oil composition of the present invention. Examples of a cooked food include grilled foods such as broiled meat and okonomiyaki (pancake with meat and vegetables); stir-fries such as fried noodles and stir-fried vegetables; and fries such as tempura, croquettes, fried fish and pork cutlet. In addition, the method for producing a cooked food of the present invention also includes the use of the edible fat and oil composition as demolding oil.

Specifically, the method comprises the steps of adding appropriate quantities of the edible fat and oil composition to a cooking utensil and heating it, adding food materials thereto, and cooking them by grilling, stir-frying or deep frying. It is possible to change as appropriate an amount of the edible fat and oil composition, heating temperature and cooking time depending on a kind of used foods, food preparation method, or the like.

### A Food Which Is Produced By Using the Edible Fat And Oil Composition of the Present Invention

Since the edible fat and oil composition of the present invention has a good flavor in itself, it is possible to obtain a food having an improved flavor by using the composition as a material of foods.

Examples of the food produced by using the edible fat and oil composition of the present invention include seasoning agents, foods produced by the above method for producing the cooked foods such as grilled foods, stir-fries and fries, boiled foods and marinated foods.

Examples of the content of the edible fat and oil composition of the present invention in food are 10-80 mass % in a seasoning agent, 1-20 mass % in a grilled food, 1-20 mass % in a stir-fry, 1-40 mass % in a fry, 1-10 mass % in a boiled food, and 5-50 mass % in a marinated food.

The edible fat and oil composition of the present invention is a composition having a flavor in itself, more specifically the composition having both a delicious flavor and lightness. Therefore, foods produced by using the edible fat and oil composition of the present invention, more specifically foods cooked by using said edible fat and oil composition or foods which used the composition as a seasoning agent have better flavor as compared to foods produced by using previously known fat and oil compositions.

The following Examples will further illustrate the present invention. They only explain the present invention and do not particularly limit the invention.

### Examples

“%” and “part” mentioned below indicate “mass %” and “part by weight” respectively unless specified otherwise. The iodine value is a value measured in accordance with the method of “Standard Methods for the Analysis of Fats, Oils and Related Materials 2.3.4.1-1996 (Japan Oil Chemists' Society)”.

### Evaluation of Flavor of the Raw Edible Fat And Oil Composition

The flavor of the raw edible fat and oil composition is compared to those of other oils.

### (1) Oils Evaluated

The following oils were used as comparison subjects:

Taihaku sesame oil (trade name: Nisshin Taihaku Sesame Oil, produced by The Nisshin OilliO Group, Ltd.);

Corn oil (trade name: Nisshin Corn Oil, produced by The Nisshin OilliO Group, Ltd., a content of fatty acids having 18 carbon atoms and at least one unsaturated bond(s) in all constituent fatty acids: 86.5 mass %);

Rice salad oil (trade name: Nisshin Rice Salad Oil, produced by The Nisshin OilliO Group, Ltd.);

Palm olein [iodine value 65] (produced by Intercontinental Specialty Fats SDN. BHD, a content of fatty acids having 18 carbon atoms and at least one unsaturated bond(s) in all constituent fatty acids: 60.5 mass %);

Safflower oil (trade name: Nisshin Safflower Oil, produced by The Nisshin OilliO Group, Ltd.);

Palm olein [iodine value 60] (trade name: Super Olein (5), produced by The Nisshin OilliO Group, Ltd., a content of fatty acids having 18 carbon atoms and at least one unsaturated bond(s) in all constituent fatty acids: 56.6 mass %);

Palm olein [iodine value 68] (produced by Intercontinental Specialty Fats SDN. BHD, a content of fatty acids having 18 carbon atoms and at least one unsaturated bond(s) in all constituent fatty acids: 63.1 mass %);

Sunflower oil (trade name: Nisshin Sunflower Oil, produced by The Nisshin OilliO Group, Ltd.); and

Canola oil (rapeseed oil) (trade name: Nisshin Canola Oil, produced by The Nisshin OilliO Group, Ltd., a content of an oleic acid in all constituent fatty acids: 61 mass %).

The edible fat and oil composition of the present invention was prepared by formulating the above palm olein [iodine value 68], corn oil and canola oil at a ratio of palm olein [iodine value 68]:corn oil:canola oil=40:30:30. This oil consisting only of these three components (palm olein+corn oil+canola oil=100 mass %) was evaluated.

### (2) Evaluation Method

The evaluation is conducted by a comparative test by 10 panelists. Each of the above oils is poured in a brown beaker so that the oil cannot be visually identified. Sample numbers of 1-10 are assigned to each beaker. Each panelist arbitrarily selects two samples and puts each sample in their mouth. Then, they select “lighter oil” and “oil having a better flavor”. Each of the above samples is compared in a round-robin system and ranked in order of points on each of lightness and flavor.

More specifically, two samples arbitrarily selected among 10 samples are compared each other first. When more than 5 panelists rate one sample higher than the other, such a sample is given one point. When 5 or less panelists rate one sample lower than the other, such a sample is not given a point. In accordance with this evaluation, Sample Nos. 1-10 were compared in a round-robin system and ranked from first place in order of points

Each sample number and evaluation results are shown in Table 1 below.

TABLE 1

| | | Flavor | Lightness |
|---|---|---|---|
| Sample No. | Sample | (ranking) | (ranking) |
| 1 | Taihaku sesame oil | 1 | 9 |
| 2 | Corn oil | 2 | 10 |
| 3 | Rice salad oil | 3 | 8 |
| 4 | Palm olein (iodine val.:68): | 4 | 4 |
| | corn oil:canola oil | | |
| 5 | Palm olein (iodine val. 65) | 5 | 6 |
| 6 | Safflower oil | 6 | 3 |
| 7 | Palm olein (iodine val. 60) | 7 | 7 |
| 8 | Palm olein (iodine val. 68) | 8 | 5 |
| 9 | Sunflower oil | 9 | 2 |
| 10 | Canola oil | 10 | 1 |

Table 1 indicates the rankings of flavor and lightness on each sample. The smaller the value of the ranking is, the higher the rank of the sample becomes, i.e., the flavor or the lightness of the sample is evaluated higher.

FIG. 1 below shows a diagram of the results of the above table.

Above FIG. 1 plots the ranking of flavor on the x-axis and the ranking of lightness on the y-axis. The rightmost grid of the flavor axis indicates first place, and the following grids starting from the right indicate second to tenth places, respectively. Similarly, the top grid of the lightness axis indicates first place, and the following grids beginning at the top indicate second to tenth places, respectively. Accordingly, it indicates that the more the value goes to the right (+ on the x-axis) in the graph, the higher the rank of the flavor of the oil is; and that the more the value goes to the upper side (+ on the y-axis) in the graph, the higher of the rank of the lightness of the oil is. A circled number described in each grid indicates each sample number in Table 1.

As clarified from the above diagram, as for previously known oils, the better “flavor” of the oil becomes, the worse “lightness” thereof becomes; and the better “lightness” of the oil becomes, the worse “flavor” thereof becomes. Accordingly, it is clarified that “flavor” is in inverse proportion to “lightness” (see Samples Nos. 1-3 and 5-10).

On the contrary, the edible fat and oil composition of the present invention (Sample No. 4) has both a delicious flavor and lightness. Thus, it is clarified that the composition of the present invention has an excellent flavor that was conventionally not possible.

### Production of Fries Using the Edible Fat And Oil Composition of the Present Invention, And Evaluation of Odor And Taste of the Fries Produced With the Fat And Oil Composition Exposed To Light Or Not Exposed To Light

### (1) Oil Used

Oils used in the example are the same as those used in the flavor evaluation of the raw oil mentioned above, and the oils described in Sample of Table 2 below were used.

### (2) Method For Producing Fries

The oil not exposed to light and the oil exposed to light in accordance with the following process were prepared on each oil of Table 2 below, and fries were produced using the oil. More specifically, fries of horse mackerel and fries of sand borer were prepared using each of the oil not exposed to light and the oil exposed to light.

The fries of horse mackerel were produced by the method comprising the steps of heating each 1000 g of the oils up to 180° C., and frying frozen horse mackerel with bread crumbs therein for 4 minutes.

The fries of sand borer were produced by the method comprising the steps of heating each 1000 g of the oils up to 180° C., and frying battered sand borer therein for 3 minutes. The battered sand borer was produced by preparing batter by mixing 160 g of water to 100 g of flour for tempura, and dipping sand borer fillet into the batter.

### (3) Condition of Light Exposure

1000 g of each edible fat and oil composition of Table 2 below was filled in an unpigmented PET container (for filling 1000 g of oil). Then, the unpigmented PET container in which the edible fat and oil composition was filled was exposed to light of 7000 Lux with a fluorescent lamp for 16 hours to obtain oil after being exposed to light.

### (4) Evaluation of the Produced Fries

The fries were evaluated by 10 panelists who ate the fries. They ate each sample and judged the odor and the taste thereof in accordance with the following evaluation standards.
Odor
10-8: feeling no odor of fish
Less than 8-6: feeling faint odor of fish
Less than 6-4: feeling some odor of fish
Less than 4: feeling strong odor of fish
Taste
⊚: feeling no odor of fish and tasty
◯: having a slight fishy aftertaste
Δ: having a fishy aftertaste
×: feeling a strong fishy odor in the mouth

### (5) Evaluation Results

TABLE 2

| | | | | Use of oil not | | Use of oil | |
|---|---|---|---|---|---|---|---|
| | | | | exposed to light | | exposed to light | |
| | | Sample | Mass ratio | Odor | Taste | Odor | Taste |
| Fry of | Exam. 1 | Palm olein (iodine val. 68): | 40:30:30 | 9.8 | ⊚ | 9.0 | ⊚ |
| horse | | corn oil:canola oil | | | | | |
| mackerel | Comp. Exam. 1 | Palm olein (iodine val. 60) | 100 | 6.2 | ◯ | — | — |
| | Comp. Exam. 2 | Palm olein (iodine val. 65) | 100 | 6.5 | ◯ | — | — |
| | Comp. Exam. 3 | Palm olein (iodine val. 68) | 100 | 6.8 | ◯ | — | — |
| | Comp. Exam. 4 | Canola oil | 100 | 2.4 | X | 2.0 | X |
| | Comp. Exam. 5 | Corn oil | 100 | 5.8 | Δ | — | — |
| | Ref. Exam. 1 | Palm olein (iodine val. 68): | 60:40 | 8.6 | ⊚ | 8.0 | ⊚ |
| | | corn oil | | | | | |
| | Ref. Exam. 2 | Palm olein (iodine val. 68): | 70:30 | 8.7 | ⊚ | 7.8 | ⊚ |
| | | corn oil | | | | | |
| | Ref. Exam. 3 | Palm olein (iodine val. 68): | 80:20 | 8.2 | ⊚ | 7.5 | ⊚ |
| | | corn oil | | | | | |
| Tempura of | Exam. 2 | Palm olein (iodine val. 68): | 40:30:30 | 9.7 | ⊚ | 9.0 | ⊚ |
| sand borer | | corn oil:canola oil | | | | | |
| | Comp. Exam. 6 | Canola oil | 100 | 3.8 | X | 2.1 | X |

As indicated in above Table 2, it is clarified that the fries of horse mackerel and the tempura of sand borer each of which were produced using the edible fat and oil composition of the present invention have better odor and taste than the fries and the tempura produced using the oils of comparative examples. Further, as for the edible fat and oil composition of the present invention, it was confirmed that the odor and the taste of the fries produced using the oil exposed to light were as good as those of the fries produced using the oil not exposed to light.

### Measurement of Amounts of Tocotrienols And Coenzyme Q10

Amount of tocotrienols and coenzyme Q10 was measured in each of the edible fat and oil compositions which were formulated as indicated in Table 3 below. The measured amount of tocotrienols is a total amount of α-tocotrienol, β-tocotrienol, γ-tocotrienol and δ-tocotrienol.

The palm olein used is a prototype of The Nisshin OilliO Group, Ltd., which has an iodine value of 69 and comprises fatty acids having 18 carbon atoms and at least one unsaturated bond(s) at an amount of 63.4 mass % in all constituent fatty acids. The corn oil used is Nisshin Corn Oil (trade name) produced by The Nisshin OilliO Group, Ltd., which comprises fatty acids having 18 carbon atoms and at least one unsaturated bond(s) at an amount of 86.5 mass % in all constituent fatty acids. The canola oil used is Nisshin Canola Oil (trade name) produced by The Nisshin OilliO Group, Ltd., which comprises 61 mass % of an oleic acid in all constituent fatty acids. Each amount of the tocotrienols and coenzyme Q10 in the fats and oils was measured with HPLC.

TABLE 3

| | | Tocotrienols | Coenzyme Q10 |
|---|---|---|---|
| | | (ppm) | (ppm) |
| Comp. Ex. 7 | Palm olein (iodine | 440 | 2.2 |
| | value 69) | | |
| Exam. 3 | Palm olein (iodine | 170 | 0.88 |
| | value 69):corn oil:canola | | |
| | oil = 40:30:30 | | |

### Measurement of An Amount of Tocotrienols

Amount of tocotrienols in the edible fat and oil compositions of the present invention prepared by using palm oleins comprising different quantities of tocotrienols was measured. The measured amount of tocotrienols is a total amount of α-tocotrienol, β-tocotrienol, γ-tocotrienol and δ-tocotrienol.

In Comparative Examples 8-10, palm oleins used were prototypes of The Nisshin OilliO Group, Ltd. having different production lots, each of which has an iodine value of 69 and comprises fatty acids having 18 carbon atoms and at least one unsaturated bond(s) at an amount of 63-64 mass % in all constituent fatty acids. In Examples 4-6, each edible fat and oil composition was produced by using, as the palm olein, each of the above palm oleins used in the corresponding comparative examples in Table 4; as the corn oil, Nisshin Corn Oil (trade name) produced by The Nisshin OilliO Group, Ltd., which comprises fatty acids having 18 carbon atoms and at least one unsaturated bond(s) at an amount of 86.5 mass % in all constituent fatty acids; and, as the canola oil, Nisshin Canola Oil (trade name) produced by The Nisshin OilliO Group, Ltd., which comprises 61 mass % of an oleic acid in all constituent fatty acids. The amount of the tocotrienols in the fats and oils was measured with HPLC.

TABLE 4

| | Amount of tocotrienols (ppm) | | |
|---|---|---|---|
| | Comp. Ex. 8 | Comp. Ex. 9 | Comp. Ex. 10 |
| Palm olein (iodine | 325 | 510 | 780 |
| value 69) | | | |
| | Exam. 4 | Exam. 5 | Exam. 6 |
| Palm olein (iodine | 130 | 200 | 310 |
| value 69):corn oil:canola | | | |
| oil = 40:30:30 | | | |

### Measurement of Amounts of Tocotrienols And Coenzyme Q10 In the Edible Fat And Oil Composition Having Different Formulation Amount

Amount of tocotrienols and coenzyme Q10 was measured in each of the edible fat and oil compositions which were formulated as indicated in Table 5 below. The measured amount of tocotrienols is a total amount of α-tocotrienol, β-tocotrienol, γ-tocotrienol and δ-tocotrienol.

Further, fries of horse mackerel were produced by the same method as that mentioned above using the oil not exposed to light of the edible fat and oil composition. The obtained fries of horse mackerel were evaluated by the same method as that mentioned above.

The palm olein used is a prototype of The Nisshin OilliO Group, Ltd., which has an iodine value of 69 and comprises fatty acids having 18 carbon atoms and at least one unsaturated bond(s) at an amount of 63.4 mass % in all constituent fatty acids. The corn oil used is Nisshin Corn Oil (trade name) produced by The Nisshin OilliO Group, Ltd., which comprises fatty acids having 18 carbon atoms and at least one unsaturated bond(s) at an amount of 86.5 mass % in all constituent fatty acids. The canola oil used is Nisshin Canola Oil (trade name) produced by The Nisshin OilliO Group, Ltd., which comprises 61 mass % of an oleic acid in all constituent fatty acids. Each amount of the tocotrienols and coenzyme Q10 in the fats and oils was measured with HPLC.

TABLE 5

| | Palm olein | | | Oil not exposed | |
|---|---|---|---|---|---|
| | (i.v. 69):corn | tocotri- | Coentyme | to light | |
| | oil:canola oil | enols(ppm) | Q10 (ppm) | Odor | Taste |
| Exam. 7 | 39:31:30 | 195 | 0.86 | 9.5 | ⊚ |
| Exam. 8 | 38:32:30 | 190 | 0.84 | 9.5 | ⊚ |
| Exam. 9 | 37:33:30 | 185 | 0.81 | 9.3 | ⊚ |
| Exam. 10 | 36:34:30 | 180 | 0.79 | 9.3 | ⊚ |
| Exam. 11 | 35:35:30 | 175 | 0.77 | 9.3 | ⊚ |
| Exam. 12 | 34:33:33 | 170 | 0.75 | 9.5 | ⊚ |

From the results of Table 5, it was clarified that both the odor and the taste were good of the fries of horse mackerel produced by using the oil not exposed to light of the edible fat and oil composition of the present invention comprising three kinds of fats and oils, i.e., palm olein (iodine value 69), corn oil and canola oil.

### Measurement of An Amount of Original Tocotrienols+Tocopherols And the Amount Thereof After the Preservation

Amount of tocotrienols+tocopherols was measured before and after the preservation thereof in the conditions mentioned in Table 6 below in each of the edible fat and oil compositions which were formulated as indicated in Table 6 below. The amount of tocotrienols +tocopherols is a total amount of α-tocopherol, β-tocopherol, γ-tocopherol, δ-tocopherol, α-tocotrienol, β-tocotrienol, γ-tocotrienol and δ-tocotrienol.

The palm olein used is a prototype of The Nisshin OilliO Group, Ltd., which has an iodine value of 69 and comprises fatty acids having 18 carbon atoms and at least one unsaturated bond(s) at an amount of 63.4 mass % in all constituent fatty acids. The corn oil used is Nisshin Corn Oil (trade name) produced by The Nisshin OilliO Group, Ltd., which comprises fatty acids having 18 carbon atoms and at least one unsaturated bond(s) at an amount of 86.5 mass % in all constituent fatty acids. The canola oil used is Nisshin Canola Oil (trade name) produced by The Nisshin OilliO Group, Ltd., which comprises 61 mass % of an oleic acid in all constituent fatty acids. Each amount of the tocotrienols and tocopherols in the fats and oils was measured with HPLC.

TABLE 6

| | Amount of tocotrienols + tocopherols (ppm) | |
|---|---|---|
| | | Example 13 |
| | Comparative Example 11 | Palm olein (iodine value 69): |
| | Palm olein (iodine value 69) | corn oil:canola oil = 40:30:30 |
| | Value in ( ) is a maintenance ratio | Value in ( ) is a maintenance ratio |
| Initial value | 440 | 620 |
| Preserved 12 wks | 400 (90.9 mass %) | 620 (100 mass %) |
| under 1000 Lux, 20° C. | | |

From the above results, it is clarified that the total amount of the tocotrienols and the tocopherols originally comprised in the edible fat and oil composition of the present invention can be maintained after the preservation thereof.

1. An edible fat and oil composition comprising palm olein having an iodine value of 64 or more, corn oil and rapeseed oil.

2. The edible fat and oil composition according to claim 1, wherein the total amount of the palm olein, the corn oil and the rapeseed oil in the whole edible fat and oil composition is 50-100 mass %.

3. The edible fat and oil composition according to claim 1, wherein the mass ratio of the palm olein to the total amount of the corn oil and the rapeseed oil is 20:80-80:20.

4. The edible fat and oil composition according to claim 1, wherein the mass ratio of the corn oil and the rapeseed oil is 20:80-80:20.

5. The edible fat and oil composition according to claim 1, wherein the iodine value of the palm olein is 64-80.

6. The edible fat and oil composition according to claim 1, wherein the composition is filled in a container at least a part of which is formed of a light transmissive material.

7. The edible fat and oil composition according to claim 6, wherein the volume of the container is 2 L or less.

8. An edible fat and oil composition comprising palm olein having an iodine value of 64 or more, corn oil and rapeseed oil, wherein the total amount of the palm olein, the corn oil and the rapeseed oil in the whole edible fat and oil composition is 50-100 mass %; the mass ratio of the palm olein to the total amount of the corn oil and the rapeseed oil is 20:80-80:20; and the mass ratio of the corn oil and the rapeseed oil is 20:80-80:20.

9. An edible fat and oil composition comprising palm olein, corn oil and rapeseed oil, wherein the composition is filled in a container of 2 L or less, at least a part of which is formed of a light transmissive material.

10. The edible fat and oil composition according to claim 1, further comprising carotene.

11. The edible fat and oil composition according to claim 1, further comprising coenzyme Q10.

12. The edible fat and oil composition according to claim 1, further comprising tocotrienols.

13. The edible fat and oil composition according to claim 1, wherein the composition further comprises tocotrienols and tocopherols, and wherein 92-100 mass % of the total amount of the tocotrienols and the tocopherols originally comprised in the composition is maintained after the preservation thereof.

14. A method for producing a cooked food which comprises cooking food materials using the edible fat and oil composition according to claim 1.

15. A food produced by using the edible fat and oil composition according to claim 1.
